(19) United States
(12) Patent Application Publication
(10) Pub. No.: US 2005/0094993 A1
(43) Pub. Date: May 5, 2005

(54) Auto-metering system

(75) Inventors: David R. Dowe, Holley, NY (US); Daniel J. Scoville, Rochester, NY (US); Robert J. Stanchus, Rochester, NY (US); Donald R. Coulter, Green Valley, AZ (US)

Correspondence Address: Milton S. Sales;Patent Legal Staff, Eastman Kodak Company, 343 State Street, Rochester, NY, 14650-2201, US

(73) Assignee: Eastman Kodak Company

(21) Appl. No.: 10/699,725

(22) Filed: Nov. 3, 2003

(51) Int. Cl. G03B 1/00

(52) U.S. Cl. 396/411

(57) ABSTRACT

An auto-metering system for use in a film camera having an automatic film advance system is provided. The auto-metering system has a sprocket wheel having a support member arranged so that when the automatic film advance system advances film, the sprocket wheel is rotated, with the sprocket wheel having a gear engagement surface and a reduction gear engaging the gear engagement surface of the sprocket wheel. The reduction gear has a lobe thereon, and is adapted to move the lobe between a first position to a second position with said movement between the first position and second position occurring at a different rate than the rate of rotation of the sprocket wheel. A metering switch is located at the second position. The metering switch changes between a first state when the cam is not at the second position and a second state when the cam is at second position. A control circuit controls operation of the film advance system based upon to the state of the metering switch. Wherein the sprocket wheel, reduction gear and lobe, are arranged so the lobe is at the second position when the film is advanced by a predetermined amount.

### FIELD OF THE INVENTION

The present invention relates to film feeding systems and methods and apparatuses for metering film movement.

### BACKGROUND OF THE INVENTION

Cameras having film feeding systems that are capable of loading and winding photographic films such as the 35 mm film or advanced photographic system (APS) film are well known. These feeding systems can be manually or automatically actuated and include metering systems that control the way in which film is advanced so that images can be recorded sequentially on separate areas of the film. Such metering systems typically are adapted to space the images recorded on the film to provide a consistent separation to prevent double exposures. Many such auto-metering systems are known in the art.

U.S. Pat. No. 4,304,480 entitled “Motor Drive Camera With Synchronization System” filed by Fukahori et al. on Oct. 24, 1978, provides one example of a motorized camera film advance system with an auto-metering system. The film advance system of the '480 patent has a film advance error detection system for synchronizing the operation of a shutter cocking system and a film winding mechanism. This system utilizes three transducers positioned adjacent to a sprocket wheel, perforations in the film, and a rewinding spindle in order to pick up signals whose frequencies are related to their speeds. By processing the signals in combination with an outer signal of a phase difference compensator, the system of the '480 patent provides, in a selective manner, a display representative of a film advance error in film winding and rewinding operations along with automatic stoppage of rotation of the motor. Electronic systems in the camera can also use one or more of the signals to determine when the film has been sufficiently advanced between frames.

FIG. 1 shows a bottom view of a diagram of a typical 35 mm film camera. As is shown in FIG. 1, camera 20 comprises a film supply space 24 for holding a film supply such as a roll 30 of film 32. Film 32 is drawn from roll 30 through an exposure area 22 in camera 20 to a film take-up area 26. Film take-up area 26 has a film advance system 34 comprising a winding structure such as a spindle 36 to which film 32 is attached and a spindle drive system 38 that rotates spindle 36 to advance film 32. A prior art auto-metering system 40 is positioned between film supply space 24 and film take-up area 26. Film movement sensor 41 detects movement of film 32 through camera 20 and provides signals representative of this movement to a controller 42. Controller 42 controls the operation of spindle drive system 38 and an exposure control system 44. Exposure control system 44 is positioned between an exposure area 22 and a lens system 46. Lens system 46 focuses light from a scene so that an image is formed upon the portion of film 32 located at exposure area 22. Exposure control system 44 controllably allows light to pass from lens system 46 to exposure area 22.

When a user of camera 20 decides to capture an image of a scene on film 32, the user of camera 20 depresses a trigger button 48. Trigger button 48 transmits a signal to controller 42 which causes controller 42 to actuate exposure control system 44. In response, exposure control system 44 allows light to pass from the scene through lens system 46 to form an image on film 32. After exposure, controller 42 actuates film advance system 34. Accordingly, spindle drive system 38 rotates spindle 36 to draw film 32 from roll 30. As this occurs, auto-metering system 40 detects movement of film 32 and provides signals to controller 42 indicative of the extent of the movement of film 32. Controller 42 determines when the signals received from film movement sensor 41 indicate that film 32 has moved by one full image frame and transmits signals to spindle drive system 38 to stop drawing film 32 from roll 30.

FIG. 2 shows a perspective view of film movement sensor 41 typically used in prior art auto-metering system 40. FIG. 3 shows a top view of film movement sensor 41 of FIG. 2. As is shown in FIGS. 1-3, film 32 consists of a base material 52 and two rows of equally spaced perforations 54 and 56 for moving film 32. A sprocket wheel 60 is also provided in camera 20. Sprocket wheel 60 consists of two support members 62 and 64 separated by connecting member 66. Each of support members 62 and 64 have eight protrusions 68 and 70 respectively that pass through perforations 54 and 56 respectively of film 32. As film 32 is moved between film supply space 24 and film take-up area 26 perforations 54 and 56 engage protrusions 68 and 70 respectively. This rotates sprocket wheel 60 as film 32 advances along direction A causing sprocket wheel 60 to rotate about axis 72 in a counter clockwise direction B.

Sprocket wheel 60 also includes a cam 74 having four lobes 76 thereon separated by valleys 78. A switch 80 is provided having electrical contacts 82 and 84 at least one of which is movable relative to the other. In FIGS. 2 and 3, contact 82 is shown as being movable. As is shown in FIGS. 2 and 3, switch 80 has a block 86 that separates contacts 82 and 84. Accordingly, switch 80 operates as a normally open switch. Cam 74 and switch 80 are arranged so that as sprocket wheel 60 rotates in response to movement of film 32, lobes 76 and valleys 78 alternatively confront contact 82. As is shown in FIG. 3, when lobe 76 confronts the movable contact, lobe 76 drives contact 82 into contact 84 to define electrical short between contacts 82 and 84. When valleys 78 confront contacts 82 and 84, contacts 82 and 84 are separated to define an electrical open between the contacts.

As is shown in FIGS. 2 and 3, cam 74 consists of four lobes 76 so that for every complete turn of sprocket wheel 60, contacts 82 and 84 are brought into contact four times. A complete rotation of sprocket wheel 60 is accomplished when eight perforations 54 and 56 of film 32 pass over sprocket wheel 60. A complete advancement of eight perforations of film 32 allows a new area of film 32 to be positioned for exposure. These areas of film 32 that are used for separate exposures are known as frames and the frames are typically positioned equidistant from each other along film 32. FIG. 2 shows three such frames, frames 87, 88 and 89.

It will be appreciated that a counter is required to count the number of closures of switch 80 and to disable film advance system 34 when a desired number of closures occurs. In order to provide precise location of film 32, it is useful to define lobes 76 so that the desired point at which film advancement is ceased does not occur between lobes 76 when valleys 78 confront switch 80. This is because it can be difficult to detect such a condition with precision. Rather, it is desirable to stop in response to the detected presence of a switch closure. Accordingly, prior art metering system 40 is typically defined so that film advancement ceases to occur in response to a detected closure of switch 80.

An advantage of the prior art metering system 40 of FIG. 1 is that any number of lobes 76 can be used in conjunction with the sprocket wheel 60 so long as sprocket wheel 60 turns only once for every eight perforations of film 32 that are moved past sprocket wheel 60. This is because, for every revolution of sprocket wheel 60, there is a fixed and predetermined number of switch closures. However, such an arrangement requires that sprocket wheel 60 is sized so that the number of protrusions 68 and 70 and the arrangement of protrusions 68 and 70 on sprocket wheel 60 conform to the geometric arrangement of perforations 54 and 56 on film 32. This can cause sprocket wheel 60 having a 1 to 1 ratio of teeth to perforations per frame to have a large diameter. Such a large diameter sprocket wheel 60 can be difficult to incorporate into smaller sized cameras.

In FIGS. 4 and 5, a different prior art metering system 40 is shown. In this arrangement, a sprocket wheel 90 is shown having two supporting members 92 and 94. Supporting members 92 and 94 are separated by a connecting member 96. Support members 92 and 94 have six protrusions 97 and 98 respectively for interfacing with film perforations 54 and 56 respectively of film 32. Sprocket wheel 90 also has a cam 100 positioned on support member 92. Cam 100 has three lobes 102 for closing electrical contact 82 against contact 84 of metering switch 80. When eight perforations of film 32 pass over sprocket wheel 90, sprocket wheel 90 will turn 1⅓ revolutions about axis 104. During the 1⅓ revolution of sprocket wheel 90, lobes 102 close metering switch electrical contacts 82 and 84 four times.

The advantage of sprocket wheel 90 of FIGS. 4 and 5 is that support members 92 and 94 of sprocket wheel 90 can be made smaller than support members 62 and 64 of sprocket wheel 60. A disadvantage of this arrangement is that the number of lobes 102 on sprocket wheel 90 must be defined based upon both the number of protrusions 97 and 98 and the number of perforations 54 and 56 per exposure area 22 on film 32. For example, the system of FIGS. 4 and 5 must use a number of lobes 102 that is a multiple of three in order to ensure that there is a lobe 102 positioned at the point at which film advancement is to be stopped. While this permits greater flexibility in the design of prior art auto metering system 40, there is still room for improvement in that there is a desire for a prior art auto metering system 40 that is not restricted by the requirements of the system described in FIGS. 4 and 5.

Prior art camera 20 also includes a film rewind system 39. Film rewind system 39 is activated to draw film 32 from film take-up area 26 back onto roll 30. In camera 20 of the prior art, controller 42 determines when film 32 is to be rewound onto roll 30 and actuates film rewind system 39. Controller 42 makes this determination by counting exposure areas or by determining that film 32 has stopped advancing between frames when film advance system 34 is active, such as where film 32 does not advance by a full exposure area within a time period defined by a controller and an associated timer.

Thus what is needed is a film advance system for use in a camera that offers the advantages of smaller size and provides more degrees of freedom of design. Further, there is a need for a film advance system that is less dependent upon electronic controllers.

### SUMMARY OF THE INVENTION

In one aspect of the invention, an auto-metering system for use in a film camera having an automatic film advance system is provided. The auto-metering system has a sprocket wheel having a support member arranged so that when the automatic film advance system advances film, the sprocket wheel is rotated, with the sprocket wheel having a gear engagement surface and a reduction gear engaging the gear engagement surface of the sprocket wheel. The reduction gear has a lobe thereon, and is adapted to move the lobe between a first position to a second position with said movement between the first position and second position occurring at a different rate than the rate of rotation of the sprocket wheel. A metering switch is located at the second position. The metering switch changes between a first state when the cam is not at the second position and a second state when the cam is at second position. A control circuit controls actuation of the film advance drive system in response to the state of the metering switch. Wherein the sprocket wheel, reduction gear and lobe, are arranged so the lobe is at the second position when the film is advanced by a predetermined amount.

In another aspect of the invention, an auto-metering system is provided for use in a camera having a film advance drive system for advancing film in a winding direction and a film rewind drive system for advancing film in a rewind direction. The auto-metering system has a sprocket wheel having a support member arranged in contact with the film so that when the film advance drive system advances the film, the sprocket wheel is rotated, with the sprocket wheel having a gear engagement surface. A reduction gear engages the gear engagement surface of the sprocket wheel. The reduction gear has a lobe thereon, with the reduction gear and lobe arranged to move the lobe between a first position and a second position with said movement between the first position and second position occurring at a different rate than the rate of rotation of the sprocket wheel. A metering switch is located at the second position and changing between a first state when the cam is not at the second position and a second state when the cam is at second position. A control circuit that activates the film advance drive system after an image is captured and deactivates the film advance drive system in response to a change in state of the metering switch. Wherein the sprocket wheel, reduction gear and lobe, are arranged so the lobe is at the second position when the film is advanced by a predetermined amount.

In still another aspect of the invention, an auto-metering system is provided for a film camera having a film advance drive system. The auto-metering system has a sprocket wheel having a support member arranged in contact with the film so that when the film advance drive system advances the film, the sprocket wheel is rotated, with the sprocket wheel having a gear engagement surface. A reduction gear engaging the gear engagement surface of the sprocket wheel, the reduction gear having a lobe thereon, with the reduction gear and lobe arranged to move the lobe between a first position to a second position with said movement between the first position and second position occurring at a different rate than the rate of rotation of the sprocket wheel. A power supply supplies energy. A metering switch located at the second position is changeable between a first state when the cam is not at the second position and a second state when the cam is at second position said metering switch electrically connected in series between the power supply and the film advance drive system said metering switch providing energy from the power supply to film advance drive system causing the film advance drive system to advance the film when the metering switch is at the first position and to interrupt the flow of energy to the film advance drive system when the metering switch is at the second position; A film advance jog circuit temporarily provides power to the film advance drive system when the metering switch is in the second position so as to move the metering switch from the second position to the first position. Wherein the sprocket wheel, reduction gear and lobe, are arranged so the lobe is at the second position when the film is advanced by a predetermined amount.

In a further aspect of the invention, an auto-metering system is provided for a film camera having a film advance drive system. The auto-metering system has a film movement follower having a film contact surface and adapted to in concert with advancement of the film by the film advance drive system and a metering switch adjustable between a first position associated with a first state and a second position associated with a second state. A transmission system is provided having a first surface for engaging the film movement follower and a second surface said conversion system adapted to receive energy from the film movement follower and to adjust the second surface to drive the metering switch from the first state to the second state when a predetermined amount of energy is received from the film movement follower. A control circuit is connected to metering switch for detecting a change in state of the metering switch and for generating a signal disabling film advance drive system in response to a detected change in state of the metering switch. Wherein the film movement follower moves through more than once cycle of movement as the predetermined amount of energy is received from film movement, and wherein the transmission converts the more than one cycle of movement of the follower into one cycle of movement the second surface.

### BRIEF DESCRIPTION OF THE DRAWINGS

FIG. 1 shows a top schematic view of an example camera of the prior art.

FIG. 2 is perspective view of a prior art auto metering system.

FIG. 3 is a top view of the prior art auto metering system of FIG. 2.

FIG. 4 illustrates a perspective view of another prior art auto metering system.

FIG. 5 illustrates a top view of the prior art auto metering system of FIG. 4.

FIG. 6 illustrates a top schematic view of an embodiment of a camera having a metering system of the present invention.

FIG. 7 illustrates a perspective view of one embodiment of the metering system of the present invention.

FIG. 8a is a top view of the embodiment of FIGS. 6 and 7 showing the point in time when the metering switch contacts have just been closed by a lobe.

FIG. 8b is the same view as FIG. 8a, but showing the point in time when the metering switch contacts have just reopened after being closed by the cam.

FIG. 8c is the same view as FIG. 8b, but showing an intermediate time during film advancement when the metering switch contacts have been open for an unspecified amount of time.

FIG. 8d is the same view as FIG. 8b, but showing the point in time just before the metering switch contacts are closed by the cam.

FIG. 9 illustrates a top schematic view of another embodiment of camera having a metering system of the present invention.

FIG. 10a is a schematic view of the embodiment of FIG. 9 showing the point in time when the metering switch contacts have just been opened by a lobe.

FIG. 10b shows the same view as FIG. 10a with a jog switch closed.

FIG. 10c is the same view as FIG. 10a, but showing the point in time when the metering switch contacts have just closed after being opened by the cam.

FIG. 10d is the same view as FIG. 10b, but showing the point in time just before the metering switch contacts are opened by the lobe.

FIG. 11 shows a schematic view of another embodiment of the present invention.

FIG. 12 shows still another schematic view of another embodiment of the present invention.

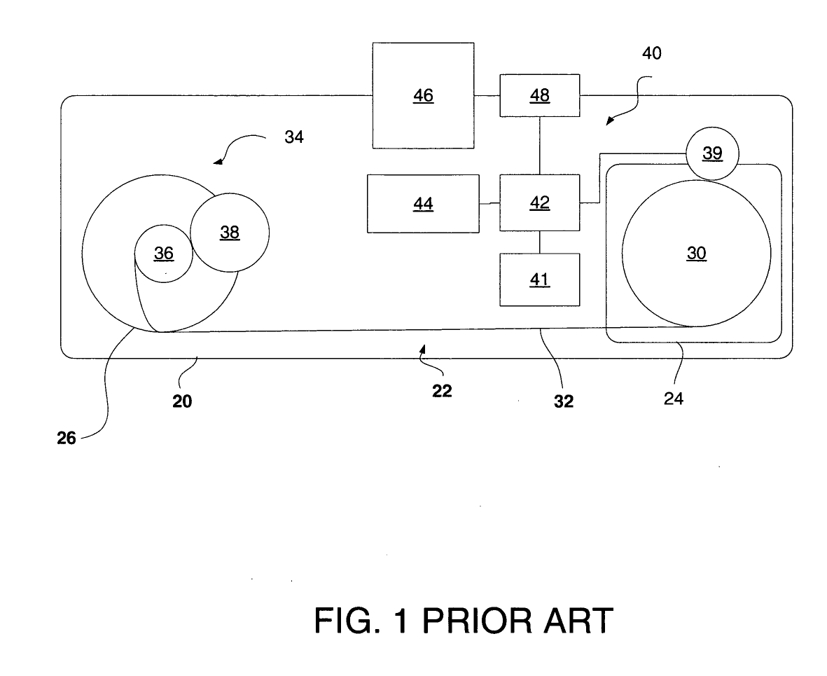

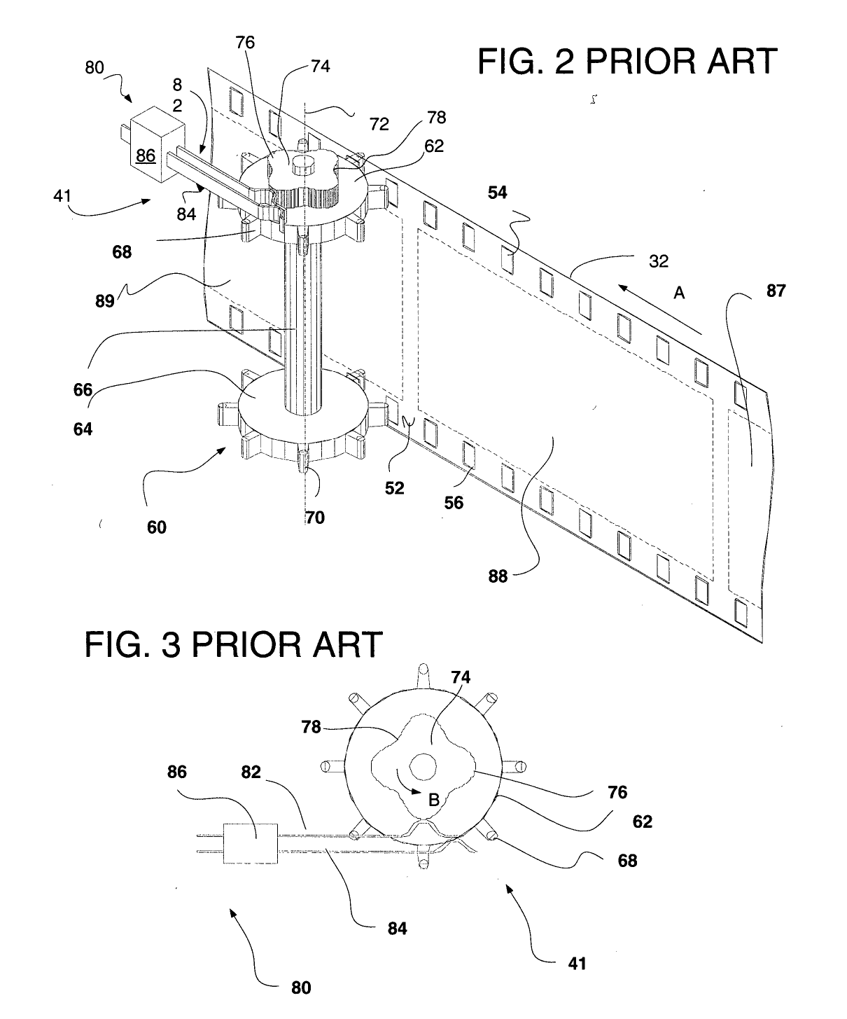

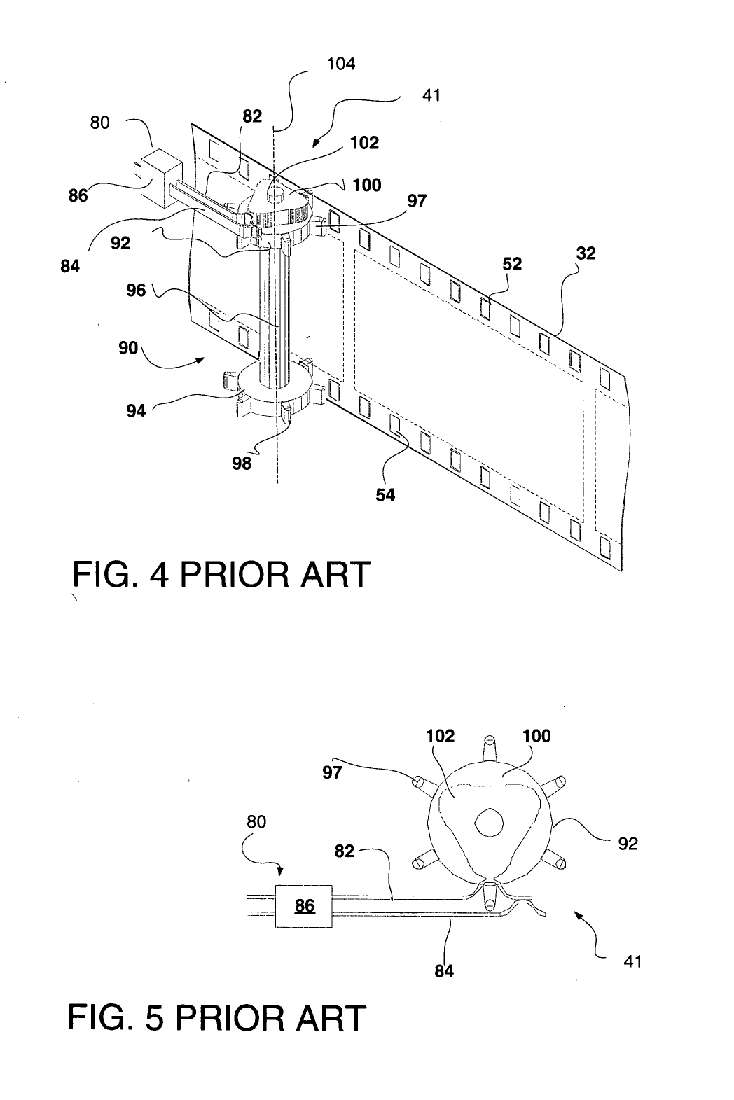

### DETAILED DESCRIPTION OF THE INVENTION

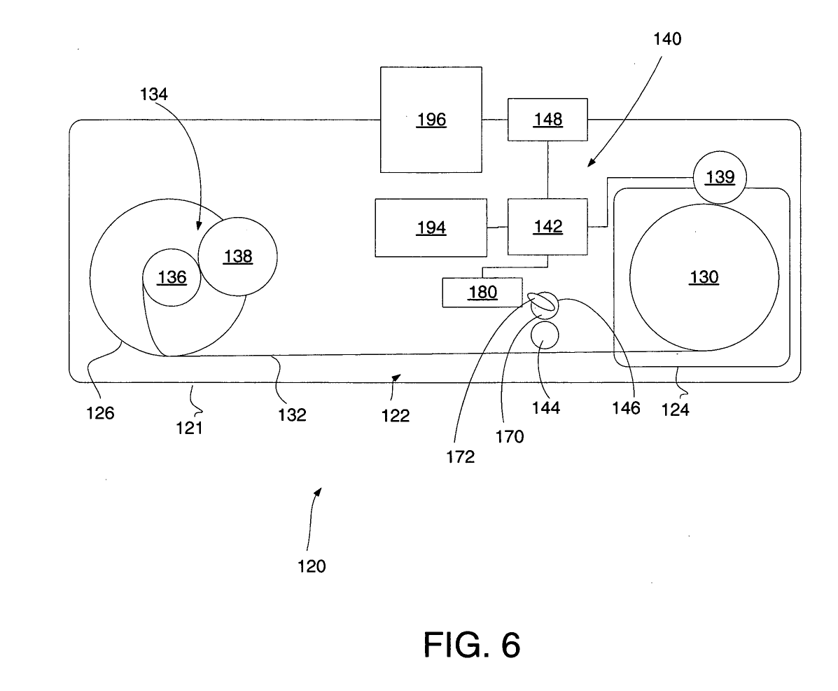

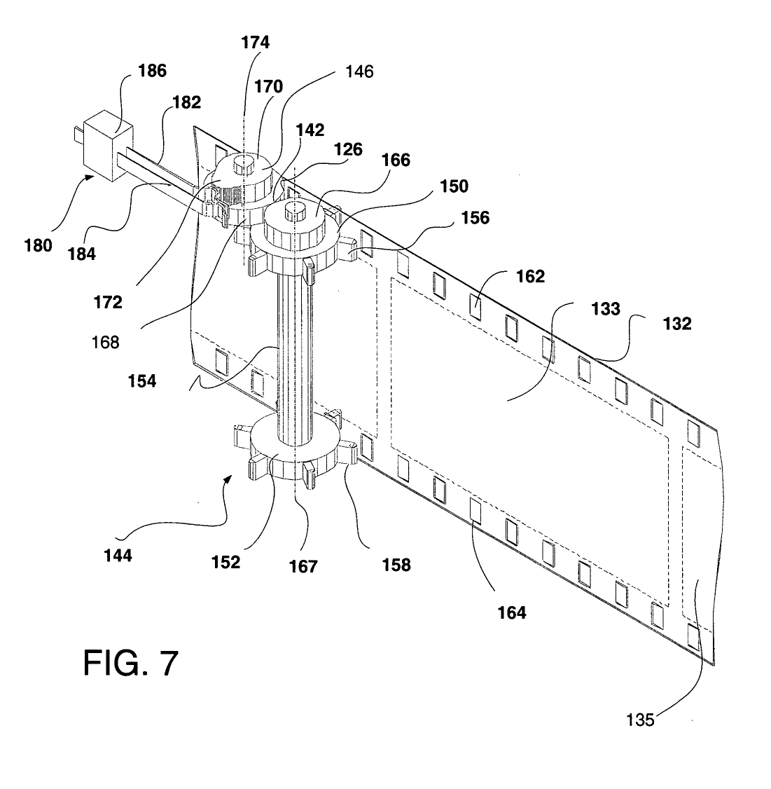

FIGS. 6 and 7 show one embodiment of a camera 120 having a metering system 140 in accordance with the present invention. FIG. 6 shows a top schematic illustration of camera 120. As is shown in FIG. 6, camera 120 comprises a camera body 121 with a film supply area 124 for holding a film supply such as a roll 130 of film 132. Film 132 is drawn from roll 130 through an exposure space 122 in camera 120 to a film take-up area 126. Film take-up area 126 has film advance system 134 comprising a winding structure such as a spindle 136 to which film 132 is attached and a film advance actuator 138 that rotates spindle 136 to advance film 132. Film advance actuator 138 can comprise, for example, a motor or any other electrically actuatable system that can rotate spindle 136.

As is shown in FIG. 6, camera 120 has an auto-metering system 140 that engages film 132 and determines when, during a film advance cycle, film 132 has been properly advanced from one frame to another, e.g., from frame 133 to frame 135. In the embodiment of FIG. 6, auto-metering system 140 comprises a control circuit 142, a sprocket wheel 144, a reduction gear 146 and a metering switch 180. As is shown in FIG. 7, sprocket wheel 144 has two support members 150 and 152 separated from each other by connecting member 154. Each support member 150 and 152 has six protrusions 156 and 158 respectively for interfacing with film perforations 162 and 164 of film 132. Sprocket wheel 144 also has a gear 166 that interfaces with reduction gear 146. Sprocket wheel 144 rotates about an axis 167.

Reduction gear 146 has a gear surface 168 that is defined to engage gear 166 in a way that provides a predetermined gear reduction ratio such as a 1 ⅓ gear reduction ratio. Reduction gear 164 also has a cam 170 having a single lobe 172. As shown in FIG. 7, reduction gear 146 rotates about an axis 174.

Metering switch 180 is positioned in the path of travel of lobe 172. In this embodiment, metering switch 180 consists of two electrical contacts 182 and 184 separated by a mounting block 186 that also functions as a separator for electrical contacts 182 and 184. This allows metering switch 180 to operate in a normally open mode. When eight perforations 162 and 164 of film 132 are drawn from film supply area 124 to film take-up area 126, perforations 162 and 164 engage protrusions 156 and 158 turning sprocket wheel 144 in a counter clockwise direction, eventually turning sprocket wheel 144, 1⅓ times about axis 167. For every 1⅓ turns of sprocket wheel 144, reduction gear 146 will turn once.

As is shown in FIG. 6, camera 120 has a control circuit 142 such as a microprocessor, a programmable analog logic device, a microcontroller, or hard wired logical structure or like circuit. Control circuit 142 is programmed or otherwise adapted to receive input signals from metering switch 180 and a capture switch 192. Capture switch 148 is typically positioned so that it can be actuated outside of camera body 121 that contains components of camera 120.

Control circuit 142 generates output signals that control the operation of film advance system 134 described above and/or a film rewind system 139 that draws film 132 from film take-up area 126 to film supply area 124. Control circuit 142 can also generate signals that control the operation of an optional electromechanical exposure control system 194. Exposure control system 194 is positioned between an exposure space 122 and a lens system 196. Lens system 196 focuses light from a scene so that an image is formed upon the portion of film 132 located at exposure space 122. Exposure control system 194 controllably allows light to pass from lens system 196 to exposure space 122.

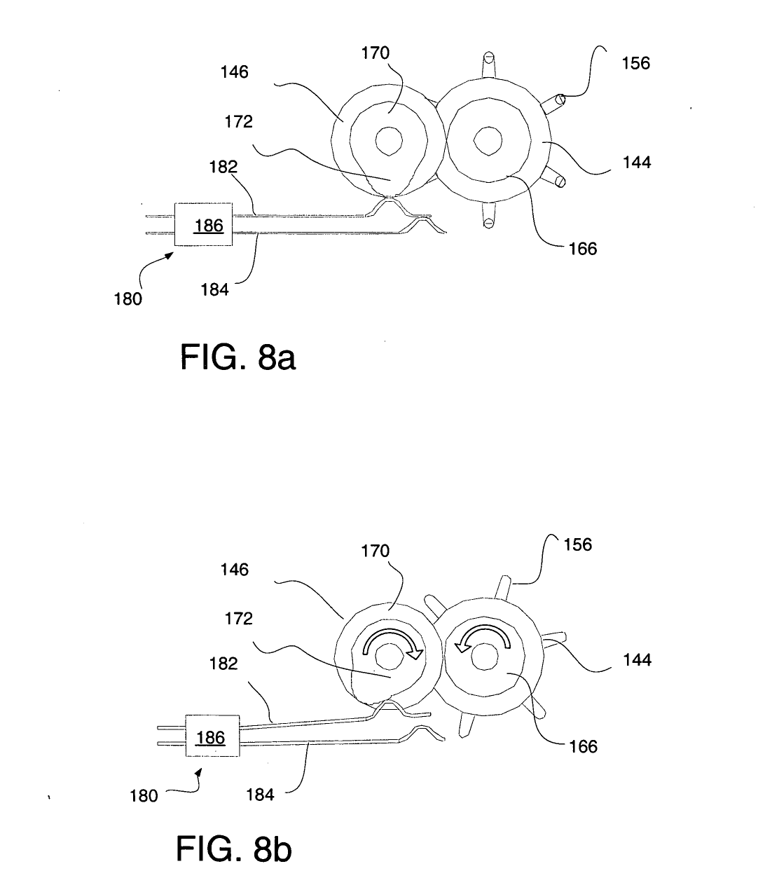

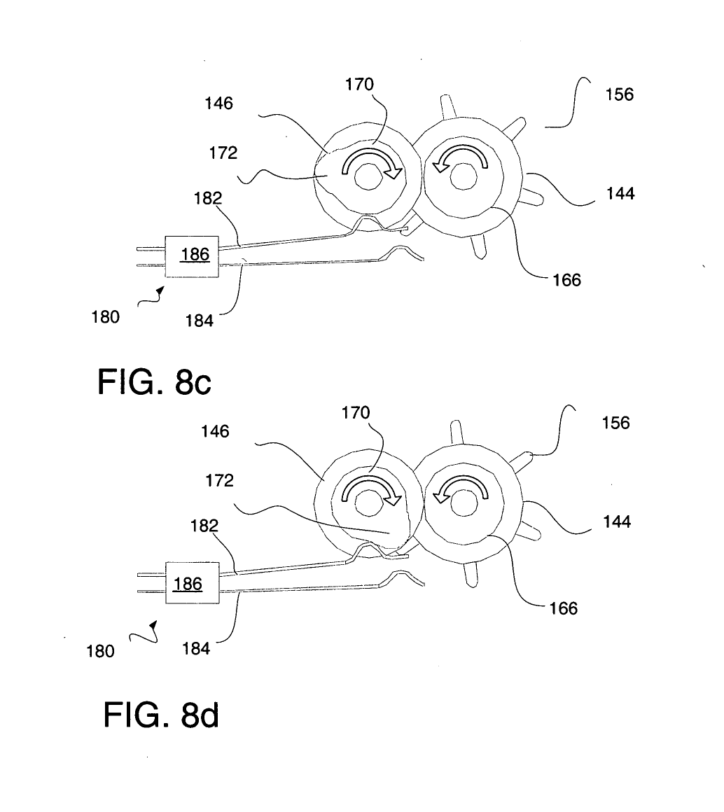

The operation of sprocket wheel 144, reduction gear 146 and metering switch 180 will now be described in detail with reference to FIGS. 6, 7 and 8a-8d. FIG. 8a shows a top view of sprocket wheel 144, reduction gear 146 and metering switch 180 of FIGS. 6 and 7 in a film advance start position. When capture switch 148 is depressed or otherwise actuated, capture switch 192 closes. Control circuit 142 detects when capture switch 148 is closed, and optionally causes exposure control system 194 to controllably expose film 132 to light from a photographic scene. After exposure, control circuit 142 sends a signal to a film advance actuator 138 to advance film 132 from a first exposure area to a second exposure area. This draws film 132 across sprocket wheel 144.

FIG. 8b shows a top view of sprocket wheel 144, reduction gear 146, and metering switch 180 of FIGS. 6 and 7 during advancement of film 132. As is shown in FIG. 8b, metering switch 180 opens during the winding process. Control circuit 142 detects when metering switch 180 is open and ensures that film advance actuator 138 continues to draw film 132 across film sprocket wheel 144. FIG. 8c shows a top view of sprocket wheel 144, reduction gear 146 and metering switch 180 of the embodiment of FIGS. 6 and 7 at a subsequent stage of film advancement.

As shown in FIG. 8d, as film advancement continues, lobe 172 engages contact 182 and begins driving contact 182 into the position shown in FIG. 8a wherein contact 182 engages contact 184. Controller 190 detects this contact and suspends operation of film advance system 134. This positions film 132 in a proper position for capturing another image.

Optionally, control circuit 142 can include a timer (not shown) and can be adapted to use the timer to provide an automatic film rewind function. In this regard, control circuit 142 can begin operating the timer when control circuit 142 begins actuating. When control circuit 142 determines that film 132 has not advanced by one full image frame within a predetermined film advance time, control circuit 142 can determine that the supply of film 132 in roll 130 is exhausted. Control circuit 142 then disables film advance system 134 and causes film rewind system 139 to engage roll 130 and cause roll 130 to draw film 132 back into film supply area 124. In this way, camera 120 provides both automatic film advance with metering and automatic film rewinding. Accordingly, the embodiment of sprocket wheel 144 shown in FIGS. 6, 7, and 8a-8d, allows for a full eight perforations of film movement with only one closure of metering switch 180. This eliminates the need for control circuit 142 to count pulses for metering switch 180 as described in the prior art. Further, the size of sprocket wheel 144 can be reduced, permitting a reduction in overall size of camera 120.

In an alternative embodiment, control circuit 142 can be adapted to operate in a fashion that, in certain circumstances, can permit increased precision in the amount of advancement of film 132. In this embodiment, when control circuit 142 detects that contact between contacts 182 and 184 is broken, as illustrated previously in FIG. 8b, control circuit 142 can cause film advance system 134 to advance film 132 at a first relatively high rate of film advance. When the film advance drive system 134, is activated at full speed, film 132 is passed over sprocket wheel 144, first causing lobe 172 of cam 170 to rotate away from contacts 182 and 184, and then causing lobe 172 to rotate toward these contacts as it completes a full rotation, as shown in FIG. 8d. In FIG. 8d lobe 172 of cam 170 is approaching contacts 180 and 182 and further rotation of cam 170 will close those contacts as shown in FIG. 8a. In this embodiment, the point at which contacts 182 and 184 engage is arranged to coincide with a point of film advancement that is near but not yet at the location of where film 132 is positioned to present a new exposure area in exposure space 122. At this point, control circuit 142 causes film advance to slow and, when control circuit 142 detects that contacts 182 and 184 have again separated, control circuit 142 stops actuation of film advance system 134. In this way, film 132 advances at a more controlled rate proximate to the moment at which control circuit 142 will instruct film advance system 134 to cease advancing film 132. By slowing the rate of film advancement immediately prior to stopping film advance, film 132 can be more precisely positioned.

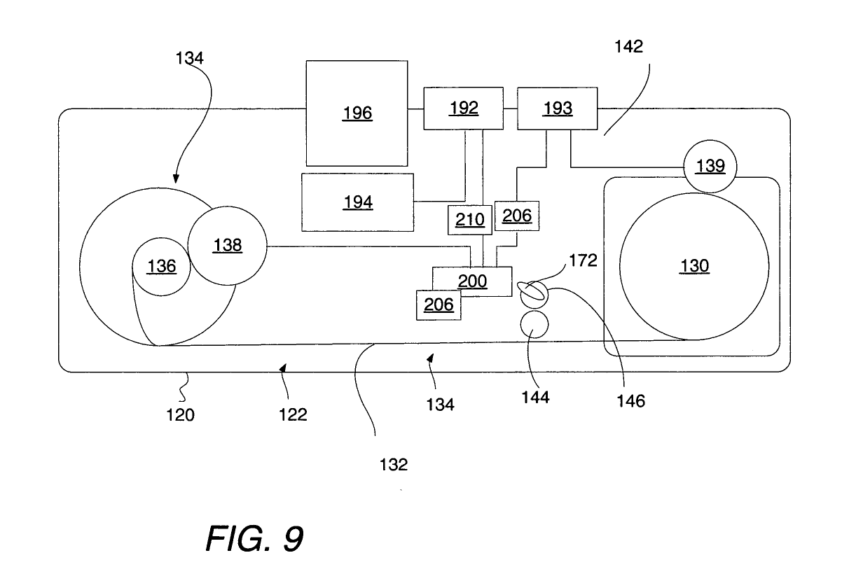

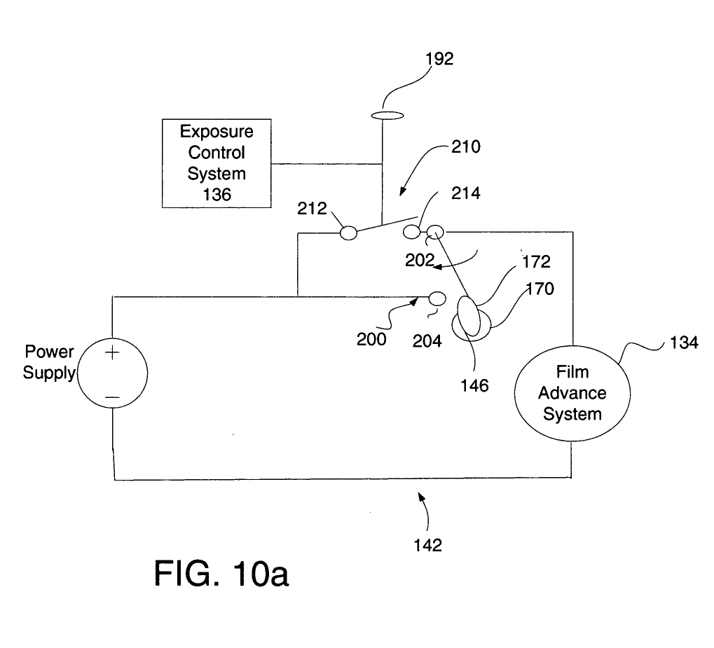

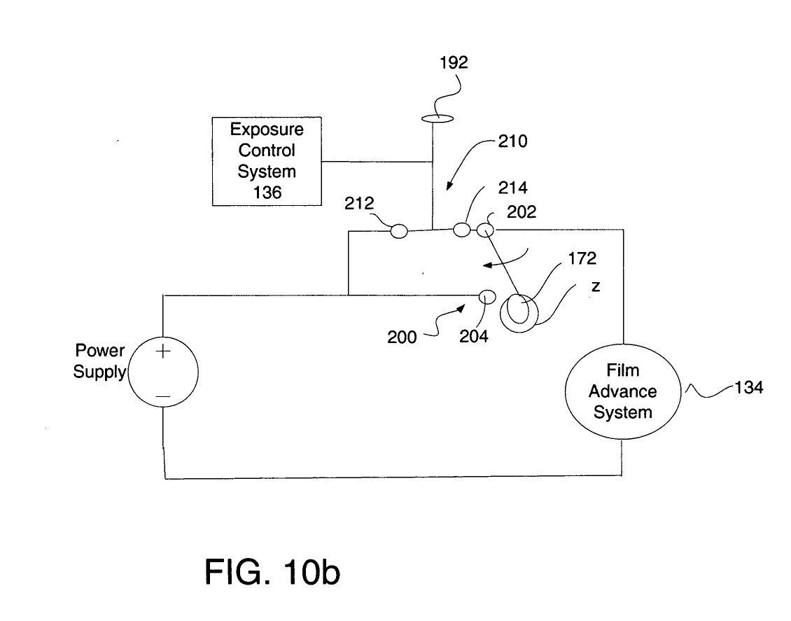

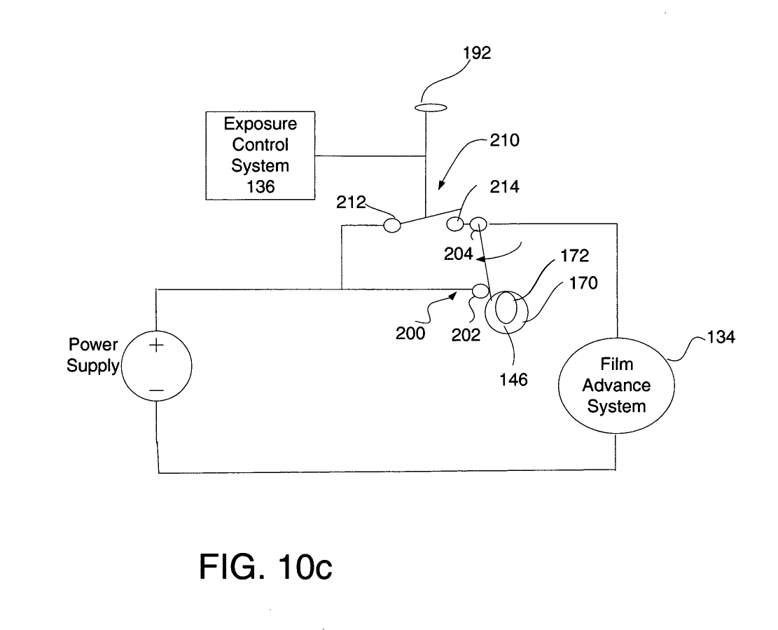

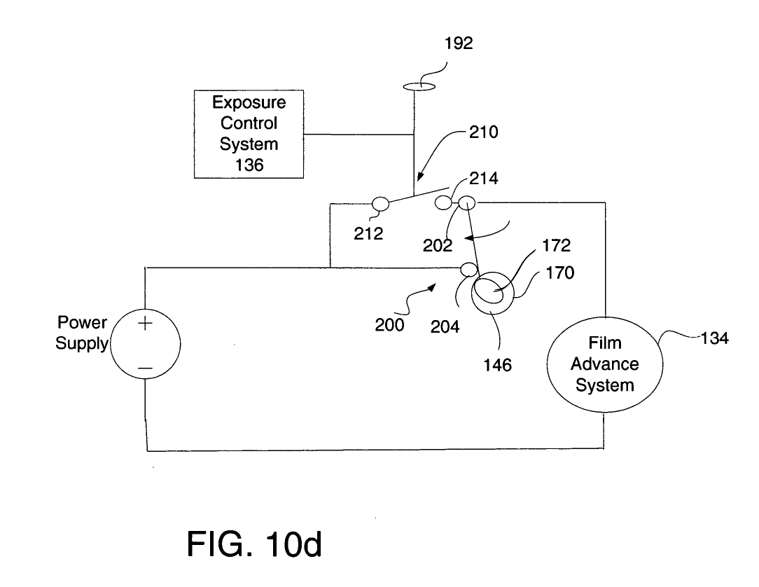

FIGS. 9 and 10a-10d show still another embodiment of the present invention. In this embodiment, control circuit 142 has a simplified design using a normally closed metering switch 200 and a jog switch 210 to provide control functions for control circuit 142.

In this embodiment, normally closed metering switch 200 is provided in series with a power supply 206 and film advance actuator 138 of film advance system 134 that advances film 132 when power is supplied to film advance system 134, from power supply 206. In this embodiment, film advance system 134 comprises spindle 136 and film advance actuator 138 as described above. Alternatively, other known electrically powered structures capable of advancing film 132 can be used. Normally closed metering switch 200 has two contacts, contact 202 and contact 204. Contact 204 is shown as being movable relative to contact 202. Contact 204 is biased toward being in contact with contact 202. This bias can be applied in any of a number of known ways including, but not limited to using mechanical, electromagnetic and/or other magnetic biasing structures to draw contact 204 into engagement with contact 202. When contact 202 engages contact 204, metering switch 200 is closed, completing an electrical path between power supply 206 and film advance system 134. This applies energy to film advance actuator 138 causing film advance actuator 138 to cooperate with spindle 136 to draw film 132 from film supply area 124 to film take-up area 126. When metering switch 200 is open, the electrical path between film advance actuator 138 and power supply 206 is interrupted ceasing operation of film advance actuator 138.

Camera 120 of FIGS. 9 and 10a-10d is provided with sprocket wheel 144 and reduction gear 146 having one lobe 172 arranged as described in the embodiment of FIGS. 6, 7, 8a-8d. However, as is shown in the embodiment of FIGS. 10a-10d, lobe 172 engages contact 204 and separates contact 204 from contact 202 as lobe 172 is rotated to confront metering switch 200. This position is shown in FIG. 10a. When lobe 172 and switch 200 are in the position shown in FIG. 10a, operation of film advance actuator 138 is suspended as described above.

Camera 120 of FIGS. 9 and 10a-10d has a capture button 192 that actuates exposure control system 194 when capture button 192 is pressed. Capture button 192 also drives a jog switch 210 having contacts 212 and 214 arranged in parallel with metering switch 200. Capture button 192, contacts 212 and 214 and exposure control system 194 are arranged so that capture button 192 is movable between a resting position, a capture position that activates exposure control system 194 and a jog position. As is shown in FIG. 10b, when capture button 192 is in the jog position, capture button 192 temporarily advances contact 212 into engagement with contact 214. This temporarily applies energy to film advance system 134 causing film advance actuator 138 to move film 132. This, in turn, causes sprocket wheel 144 and reduction gear 146 to move. This moves lobe 172 and this movement is sufficient to cause lobe 172 to separate from contact 202. Contact 202 is then urged back into contact 204 as a result of the bias applied against contact 202. The temporary engagement of contacts to 212 and 214 can be provided in a variety of ways. For example, in the embodiment shown, capture button 192 is defined for reciprocal movement allowing capture button 192 to be depressed from a resting position to a capture position and then released. A biasing member such as a spring urges capture button 192 away from the capture position to the rest position. In such an embodiment, the jog position can be defined at a position in a path of travel of capture button 192 that will cause actuation of exposure control system 194 to expose film 132 before contacts 212 and 214 are closed. The biasing member can then be arranged to slow actuation of capture button 192 to provide sufficient time between the actuation of the exposure control system 194 and the movement of the film 132 so that the film 132 does not move during exposure. Alternatively, structures can be used that will cause contacts 212 and 214 to engage as capture button 192 returns along a reciprocating path from the capture position to the rest position.

As shown in FIG. 10c, after lobe 172 separates from contact 202 film advance actuator 138 is actuated to advance film 132. This advance will continue as long as contacts 202 and 204 remain in contact.

However, as shown in FIG. 10d, as film 132 is advanced, sprocket wheel 144 and reduction gear 146 rotate again bringing lobe 172 into contact with contact 202. Further movement of film 132 beyond the point at which this occurs, drives contact 202 away from contact 204, returning the camera 120 to the state shown in FIG. 10a. The system will provide adequate metering of film 132 without requiring use of an expensive control circuit 142, so long as sprocket wheel 144 and reduction gear 146 cooperate so that lobe 172 is rotated to engage contact 202 after film 132 has been moved by a predetermined frame separation distance. In this way, a low-cost and low-profile camera can be provided having an auto-metering system.

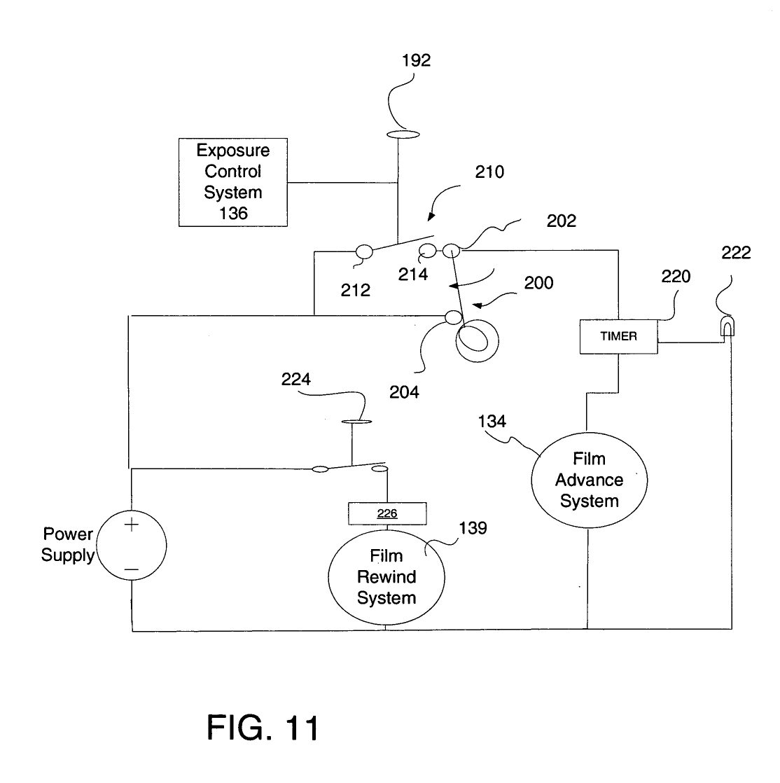

Another alternative embodiment is shown in FIG. 11. This alternative embodiment is substantially similar to the embodiment of FIGS. 9 and 10a-10d except that a timer 220 controls the flow of electrical energy to film advance system 134. In the event that film advance system 134 fails to advance film by one frame during the predetermined time established by timer 220, timer 220 disables film advance system 134 and optionally provides a warning to a user of the camera of the embodiment of FIG. 11 by way of, for example, light 222. A rewind switch 224 is provided that allows a user to directly cause energy in power supply 206 to flow to rewind drive system 139 to permit rewind of film 132. An optionally rewind timer 226 can be used to automatically discontinue the rewind process after a period of time.

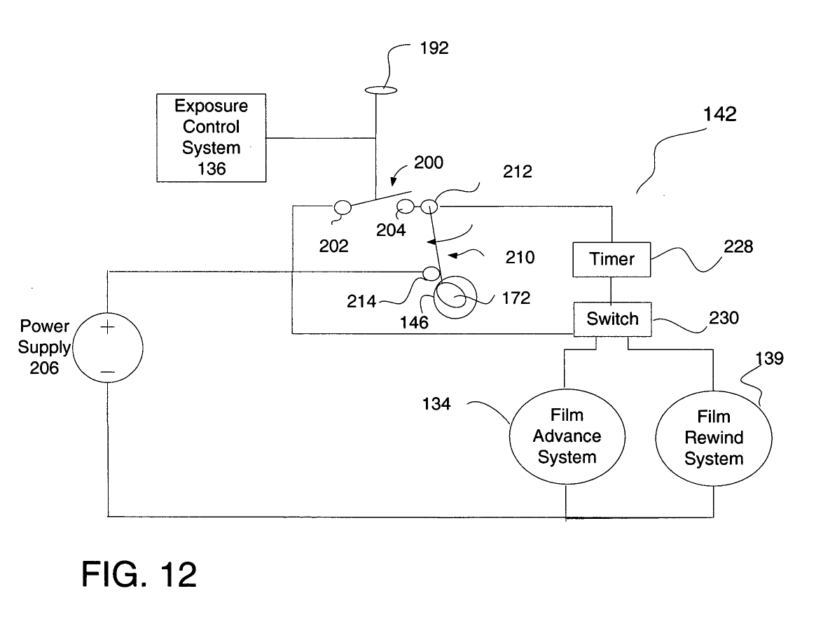

FIG. 12 shows the embodiment of FIGS. 6, 7, and 8a-8d having control circuit 142 adapted to provide both automatic metering film advance and automatic rewind functions. As is shown in FIG. 12, in this embodiment, control circuit 142 includes a timer 220 which controls a switch 228. Timer controlled switch 230 controllably directs the flow of electrical energy from power supply 206 to either one of film advance system 134 or film rewind system 139. In operation, timer 228 causes switch 230 to direct any received electrical energy to film advance system 134 for a predetermined period of time after energy is supplied to timer 228, for example, when metering switch 200 or jog switch 210 closes. This allows film advance system 134 to operate in the manner described above with reference to FIGS. 6, 7, and 8a-8d during film winding operations.

In this embodiment however, timer 228 begins measuring a predetermined period of time as soon as energy is supplied to timer 228. The predetermined time period is established so that it is longer than the amount of time required for the film advance system 134 to advance film 132 by one full frame. Thus, if film 132 is advanced by one full frame during the predetermined time period, metering switch 200 is opened cutting off the flow of electrical energy to timer 228 is cut off suspending operation of film advance system 134. However, if timer 228 reaches the predetermined time period without an interruption, then timer 228 causes switch 230 to execute a rewind operation by shifting the flow of energy from film advance drive system 134 to film rewind system 139. Energy can be applied to film rewind system 139 for a predetermined period of time determined by the timer, or alternatively, a film presence detection switch (not shown) can be placed in camera 120 such as in exposure space 122 to determine when film 132 has been rewound. Such a film presence switch would disable the flow of electrical energy to timer 228 resetting timer 230.

In the above described embodiments, sprocket wheel 144 has been shown having to support members 150 and 152. Each support members 150 and 152 has been described as having protrusions 156 and 158 to engage film perforations 162 and 164 in film 132. However, in certain embodiments, for example, in cameras that use the advanced photographic system, sprocket wheel 144 may comprise only one support member. In such embodiments, sprocket wheel 144 can optionally not rely upon the use of protrusions 156 and 158. Instead, sprocket wheel 144 can, in these embodiments, is a use a film engagement surface such as a rubberized wheel or other structure to confront film 132 in a non-image bearing area of film 132 so as to follow the movement of film 132.

In the above described embodiments, reduction gear 146 has been shown as a conventional rotating gear. However, in other embodiments, reduction gear 146 can comprise a linear gear arrangement such as rack with sprocket wheel 144 acting as a pinion to drive the rack type embodiment of reduction gear 146 between a first position that does not confront metering switch 180 and a second position that does confront metering switch 180. Reduction gear 146 can also comprise an arrangement of a belt, chain, transmission or other structure.

Further, in the above described embodiments, sprocket wheel 144 and reduction gear 146 have been shown as being directly connected. In other embodiments of the invention, sprocket wheel 144 and reduction gear 146 can be joined by intermediate structures such as additional reduction gear, and/or belts, cables, chains, a transmission or other similar structure for conveying the rotation energy of sprocket wheel 144 to reduction gear 146.

The invention has been described in detail with particular reference to certain preferred embodiments thereof, but it will be understood that variations and modifications can be effected within the spirit and scope of the invention.

### Parts List

20 camera
22 exposure area
24 film supply space
26 film take-up area
30 roll
32 film
34 film advance system
36 spindle
38 spindle drive system
39 film rewind system
40 prior art auto-metering system
41 film movement sensor
42 controller
44 exposure control system
46 lens system
48 trigger button
52 base material
54 perforations
56 perforations
60 sprocket wheel
62 support members
64 support members
66 connecting member
68 protrusions
70 protrusions
72 axis
74 cam
76 lobes
78 valley
80 switch
82 contact
84 contact
86 block
87 frame
88 frame
89 frame
90 sprocket wheel
92 support member
94 support member
96 connecting member
97 protrusions
98 protrusions
100 cam
102 lobes
104 axis
110 film rewind system
120 camera
121 camera body
122 exposure space
124 film supply area
126 film take-up area
130 roll
132 film
133 frame
134 film advance system
135 frame
136 spindle
138 film advance actuator
139 film rewind system
140 auto-metering system
142 control circuit
144 sprocket wheel
146 reduction gear
148 switch
150 support member
152 support member
154 connecting member
156 protrusions
158 protrusions
162 film perforations
164 film perforations
166 gear
167 axis
168 gear surface
170 cam
172 lobe
174 axis
180 metering switch
182 contacts
184 contacts
186 mounting block
192 capture button
194 exposure control system
196 lens system
200 metering switch
202 contact
204 contact
206 power supply
210 jog switch
212 contact
214 contact
220 timer
222 light
224 rewind switch
226 rewind timer
228 timer
230 timer controlled switch
A film advance direction
B sprocket wheel rotation

1. An auto-metering system for use in a film camera having an automatic film advance system, the auto-metering system comprising:
a sprocket wheel having a support member arranged so that when the automatic film advance system advances film, the sprocket wheel is rotated, with the sprocket wheel having a gear engagement surface;
a reduction gear engaging the gear engagement surface of the sprocket wheel, the reduction gear having a lobe thereon, and adapted to move the lobe between a first position and a second position with said movement between the first position and second position occurring at a different rate than the rate of rotation of the sprocket wheel;
a metering switch located at the second position and changing between a first state when the lobe is not at the second position and a second state when the lobe is at second position; and
a control circuit that controls operation of the film advance system based upon to the state of the metering switch;
wherein sprocket wheel, reduction gear and lobe, are arranged so the lobe is at the second position when the film is advanced by a predetermined amount.

2. The auto-metering system of claim 1, wherein the sprocket wheel, reduction gear, and lobe are arranged so that the lobe reaches the second position more than once as a film is advanced by a predetermined amount, and wherein the control circuit is adapted to control actuation of film advance drive system based upon the number of times that the lobe has been moved to the second position.

3. The auto-metering system of claim 1, wherein the predetermined amount of film advancement is smaller than a full frame, and wherein the control system is adapted to cause the film advance drive system to move the film at a first rate of film advancement before the lobe reaches the second position, at a second, slower, rate of film advance when the lobe reaches the second position and to cease film advance a predetermined period of time after the lobe reaches the second position.

4. The auto-metering system of claim 1, wherein the film has perforations and the support member has protrusions adapted to engage the film perforations with a number of protrusions on the sprocket wheel being fewer than the number of perforations on the film corresponding to the predetermined amount of film advancement.

5. The auto-metering system of claim 1, wherein the sprocket wheel has a diameter having a circumference that is smaller than the predetermined length of film.

6. The auto-metering system of claim 1, wherein the reduction gear has more than one lobe and wherein the sprocket wheel, reduction gear, and lobe are arranged so that at least one lobe reaches the second position when the film has been advanced by a predetermined amount and wherein the control circuit controls operation of the film advance system based upon detecting the number of times that a lobe has been positioned at the second position.

7. The auto-metering system of claim 1, wherein the reduction gear comprises one of a rotatable gear, a pinion, a belt and a transmission.

8. The auto-metering system of claim 1, wherein the control circuit comprises one of a microcontroller, microprocessor, programmable analog device, or arrangement of discrete electronic components.

9. The auto-metering system of claim 1, wherein the control circuit comprises the metering switch and a jog switch with the metering switch comprising a normally closed switch connected in series between a power supply and the film advance system said normally closed switch being positioned so that when the lobe confronts the metering switch, the lobe opens the metering switch, and wherein the jog switch is connected in parallel with the normally closed metering switch with the jog switch being adapted to cause a temporary advance of the film sprocket wheel, reduction gear and lobe sufficient to move the lobe from a position confronting the metering switch to a position separated from the metering switch.

10. The auto-metering system of claim 1, wherein the control circuit further comprises a timer adapted to begin measuring a predetermined period of time when power is supplied to film advance system and a switch controlled by the timer that disables the film advance system when the film has not advanced by the predetermined amount in the predetermined period of time.

11. An auto-metering system for use in a camera having a film advance system for advancing film in a winding direction and a film rewind system for advancing film in a rewind direction, the auto-metering system comprising:
a sprocket wheel having a support member arranged in contact with the film so that when the film advance drive system advances the film, the sprocket wheel is rotated, with the sprocket wheel having a gear engagement surface;
a reduction gear engaging the gear engagement surface of the sprocket wheel, the reduction gear having a lobe thereon, with the reduction gear and lobe arranged to move the lobe between a first position and a second position with said movement between the first position and second position occurring at a different rate than the rate of rotation of the sprocket wheel;
a metering switch located at the second position and changing between a first state when the cam is not at the second position and a second state when the cam is at second position; and
a control circuit that activates the film advance drive system after an image is captured and deactivates the film advance drive system in response to a change in state of the metering switch;
wherein the sprocket wheel, reduction gear and lobe, are arranged so the lobe is at the second position when the film is advanced by a predetermined amount.

12. The auto-metering system of claim 11, wherein said control circuit comprises a power supply, and a timer, and wherein said metering switch causes power to be supplied to control switch when the metering switch is in the first state and wherein said control switch enables said film advance system in response to signals from the timer, with the timer being adapted to generate signals causing the control switch to enable the film advance system so long as a predetermined period of time has not elapsed since the metering switch entered the first state.

13. The auto-metering system of claim 111 wherein said timer causes the switch to disable the film advance system after the predetermined period of time has elapsed.

14. The auto-metering system of claim 11, wherein said timer causes the switch to enable the film rewind system after the predetermined period of time.

15. An auto-metering system for a film camera having a film advance system, the auto-metering system comprising:
a sprocket wheel having a support member arranged in contact with the film so that when the film advance system advances the film, the sprocket wheel is rotated, with the sprocket wheel having a gear engagement surface;
a reduction gear engaging the gear engagement surface of the sprocket wheel, the reduction gear having a lobe thereon, with the reduction gear and lobe arranged to move the lobe between a first position and a second position with said movement between the first position and second position occurring at a different rate than the rate of rotation of the sprocket wheel;
a power supply for supplying energy;
a metering switch located at the second position and changeable between a first state when the cam is not at the second position and a second state when the cam is at the second position said metering switch electrically connected in series between the power supply and the film advance system said metering switch providing energy from the power supply to film advance system causing the film advance system to advance the film when the metering switch is at the first position and to interrupt the flow of energy to the film advance system when the metering switch is at the second position; and
a film advance jog circuit for temporarily providing power to the film advance system when the metering switch is in the second position so as to move the metering switch from the second position to the first position;
wherein the sprocket wheel, reduction gear and lobe, are arranged so the lobe is at the second position when the film is advanced by a predetermined amount.

16. An auto-metering system for a film camera having a film advance drive system, the auto-metering system comprising:
a film movement follower having a film contact surface and adapted to in concert with advancement of the film by the film advance drive system;
a metering switch adjustable between a first position associated with a first state and a second position associated with a second state;
a transmission system having a first surface for engaging the film movement follower and a second surface said conversion system adapted to receive energy from the film movement follower and to adjust the second surface to drive the metering switch from the first state to the second state when a predetermined amount of energy is received from the film movement follower; and
a control circuit connected to metering switch for detecting a change in state of the metering switch and for generating a signal disabling film advance system in response to a detected change in state of the metering switch,
wherein the film movement follower moves through more than once cycle of movement as the predetermined amount of energy is received from film movement, and wherein the transmission converts the more than one cycle of movement of the follower into one cycle of movement the second surface.

17. The auto-metering system of claim 16 wherein said control circuit causes the film advance system to operate at a first rate of film movement in one state, another rate of operation when the state of the metering switch changes, and stops operation of the film advance system at a predetermined period of time after the change of state.
